(19) United States
(12) Patent Application Publication
(10) Pub. No.: US 2025/0346168 A1
(43) Pub. Date: Nov. 13, 2025

(54) Vehicle-mounted Cup Holder

(71) Applicant: Ningbo Xuyou Intelligent Technology Co., LTD, Yuyao (CN)

(72) Inventor: Liangliang Zhou, Yuyao (CN)

(21) Appl. No.: 18/675,019

(22) Filed: May 27, 2024

(30) Foreign Application Priority Data
May 8, 2024 (CN) 202420987874.X

(51) Int. Cl. B60N 3/10

(52) U.S. Cl. CPC B60N 3/106; B60N 3/103

(57) ABSTRACT

The present disclosure belongs to the technical field of vehicle-mounted cup holders, and specifically discloses a vehicle-mounted cup holder, including a housing and a telescopic base, a driving assembly, and an adjusting assembly. The housing and the telescopic base are configured to be retractable. The driving assembly is disposed inside the housing. The adjusting assembly is located on a top of the housing and cooperatively connected to the driving assembly, and the adjusting assembly is configured to fix cups of different diameters. According to the present disclosure, due to arrangement of the adjusting assembly, a cup holder can be driven to be engaged by way of a first gear motor, and thus the vehicle-mounted cup holder can achieve automatic clamping and releasing of the cup without a need for additional operation by a user, which improves convenience and safety of use.

### CROSS REFERENCE TO RELATED APPLICATIONS

The present application claims the benefit of Chinese Patent Application No. 202420987874.X filed on May 8, 2024, the contents of which are incorporated herein by reference in their entirety.

### TECHNICAL FIELD

The present application relates to the technical field of vehicle-mounted cup holders, and in particular to a vehicle-mounted cup holder.

### BACKGROUND

A vehicle-mounted cup holder is a device installed inside a car, which is used for holding cups, water bottles, or other beverage containers during driving. It is usually located on a center console of the car or in a space between seats thereof, providing a stable support platform to prevent beverages from tilting or tipping out during driving.

The existing telescopic fixed cup holders all need to be operated with both hands, and there is no cup holder that can be electrically driven to open and close, so that a driver will spend extra time and energy in operating the cup holder; and in some cases, for example, during driving, a user may only be able to operate the cup holder with one hand, making it inconvenient to operate the cup holder with both hands.

### SUMMARY

In order to solve the above problems, the present application provides a vehicle-mounted cup holder.

The vehicle-mounted cup holder provided by the present application adopts the following technical solutions:

A vehicle-mounted cup holder includes: a housing and a telescopic base, where the housing and the telescopic base are configured to be retractable;
a driving assembly, disposed inside the housing; and
an adjusting assembly, located on a top of the housing and cooperatively connected to the driving assembly, the adjusting assembly being configured to fix cups of different diameters, and the adjusting assembly opening during placement of the cup on the top of the housing, and clamping after completion of the placement.

By adopting the above technical solution, a cup holder can be driven to be engaged by way of a first gear motor without a need for additional operation by a user, which improves convenience and safety of use.

Further, the driving assembly includes: a first gear motor, located inside the housing;
a first gear, fixedly connected to an output end of the first gear motor by way of a rotating shaft; and
a first annular gear, rotatably connected to the housing, the first gear driving the first annular gear to rotate.

By adopting the above technical solution, the driving assembly can drive moving blocks to move.

Further, the adjusting assembly includes a first threaded track, and the first threaded track is fixedly connected to a top of a first annular gear; a plurality of bumps are connected to the top end of the housing, and the plurality of bumps are respectively located at inner sides of corresponding moving blocks; each of the moving blocks is slidably connected to the first threaded track, a plurality of sliding grooves are provided inside the housing, the plurality of moving blocks are slidably connected to the sliding grooves, and the plurality of moving blocks are driven to move horizontally by rotation of the first threaded track; and a telescopic assembly is disposed below the adjusting assembly.

Further, the telescopic assembly includes a second gear motor, and an output end of the second gear motor is connected to a second gear by way of a rotating shaft; a second annular gear is rotatably connected inside the housing, and a bottom of the second annular gear is fixedly connected to a second threaded track; one end of the second threaded track is slidably connected with a plurality of moving plates, the plurality of sliding grooves are provided at one end of the housing, and the plurality of sliding grooves are slidably connected to the corresponding moving plates, respectively; and the plurality of moving plates are horizontally retractable and can be more tightly connected to an inner wall of an original cup holder.

By adopting the above technical solution, the telescopic assembly is capable of enabling soft rubber inserts to contact with the inner wall of the original cup holder, which can form a stable support with the original cup holder while avoiding the original cup holder being scratched, making it fit more tightly.

Further, each of the plurality of moving plates is internally provided a soft rubber insert, and a plurality of soft rubber inserts can avoid the inner wall of the original cup holder being scratched when in contact with same.

Further, an expandable base is disposed at one end of the housing, a connecting ring is fixedly connected inside the expandable base, and the connecting ring is rotatably connected to the housing.

By adopting the above technical solution, the expandable base can be expanded to form some other storage spaces in the later stage, such as providing a storage tray, a holder for storing french fries, a mobile phone holder, and other functions.

Further, the connecting ring is internally provided with a plurality of through holes; one end of the expandable base is slidably connected to a press block, one end of the press block is fixedly connected to a spring, and one end of the spring far away from the press block is fixedly connected to the expandable base; one end of the press block is fixedly connected to a connecting plate, and the connecting plate is internally provided with a chute; a clamping rod is slidably connected inside the expandable base, one end of the clamping rod is slidably connected to the chute formed in the connecting plate, and an other end of the clamping rod is matched with the through hole; one end of the expandable base is in a threaded connection with a function extension lever; and the clamping rod is configured to rotate and lock the expandable base.

Further, the top of the housing is fixedly connected with a cushion, the housing is in a threaded connection with the telescopic base, and the telescopic base can adjust an overall length of the housing so as to adapt to a deeper original cup holder.

By adopting the above technical solution, the telescopic base can adjust the overall length of the housing, avoiding bottom suspension of a groove between the original cup holder and the vehicle-mounted cup holder.

In summary, the present application includes at least one of the following beneficial technical effects:

(1) According to the present disclosure, due to arrangement of the adjusting assembly, the cup holder can be driven to be engaged by way of the first gear motor. Firstly, motor drive can be achieved through a simple button or switch, without excessive power or manual adjustment by a user, thus improving convenience of operation and user experience. Secondly, the motor drive can accurately control the adjustment of the cup holder so as to ensure that each adjustment can be precise and in place, avoiding errors and instability that may be caused by manual operation. Thirdly, by way of the motor drive, the vehicle-mounted cup holder can achieve automatic clamping and releasing of the cup without the need for additional operation by a user, which improves convenience and safety of use.

(2) Due to arrangement of the telescopic assembly, the present disclosure allows the soft rubber inserts to contact with the inner wall of the original cup holder, which forms a stable support with the original cup holder while avoiding the original cup holder being scratched.

(3) According to the present disclosure, the overall length of the housing can be adjusted by way of the telescopic base. The original cup holders of some cars are relatively deep, but the telescopic base of the present disclosure is configured to elongate the overall length of the housing during installation, which avoids the bottom suspension of a groove between the original cup holder and the vehicle-mounted cup holder.

### BRIEF DESCRIPTION OF FIGURES

FIG. 1 is a schematic diagram of the overall structure of the present disclosure;

FIG. 2 is a schematic diagram of the connection structure between a moving block and a first threaded track according to the present disclosure;

FIG. 3 is a schematic diagram of the connection structure between a first gear motor and a first gear according to the present disclosure;

FIG. 4 is a schematic diagram of the connection structure between a press block and a spring according to the present disclosure;

FIG. 5 is a schematic diagram of the overall structure of moving blocks of the present disclosure;

FIG. 6 is a schematic diagram of the connection structure between a second gear motor and a second gear according to the present disclosure;

FIG. 7 is a schematic diagram of the connection structure between a housing and a telescopic base according to the present disclosure; and

FIG. 8 is a schematic diagram of the telescopic structure of a telescopic base according to the present disclosure.

The following reference numerals on the drawings are described as follows: 1. denotes a housing; 2 denotes moving blocks; 3 denotes a first threaded track; 4 denotes an expandable base; 5 denotes a function extension lever; 6 denotes a first gear motor; 7 denotes a first gear; 8 denotes a first annular gear; 9 denotes a connecting ring; 10 denotes a clamping rod; 11 denotes a press block; 12 denotes a spring; 13 denotes a connecting plate; 14 denotes moving plates; 15 denotes soft rubber inserts; 16 denotes a telescopic base; 17 denotes a second gear motor; 18 denotes a second gear; 19 denotes a second annular gear; 20 denotes a second threaded track; and 21 denotes bumps.

### DETAILED DESCRIPTION

The technical solutions in embodiments of the present application will be described clearly and completely hereinafter with reference to the accompanying drawings in the embodiments of the present application. Apparently, the described embodiments are only a part rather than all of the embodiments of the present application. Based on the embodiments of the present application, all other embodiments obtained by those of ordinary skill in the art without making creative efforts shall fall within the scope of protection of the present application.

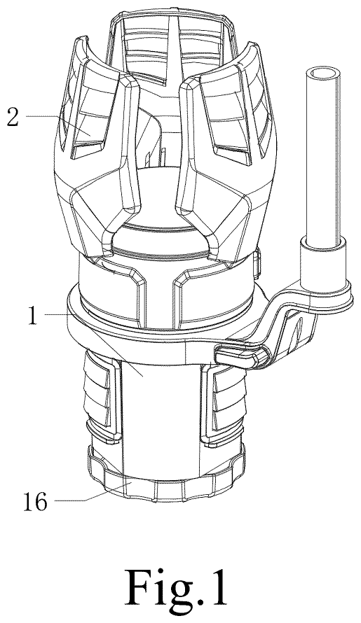

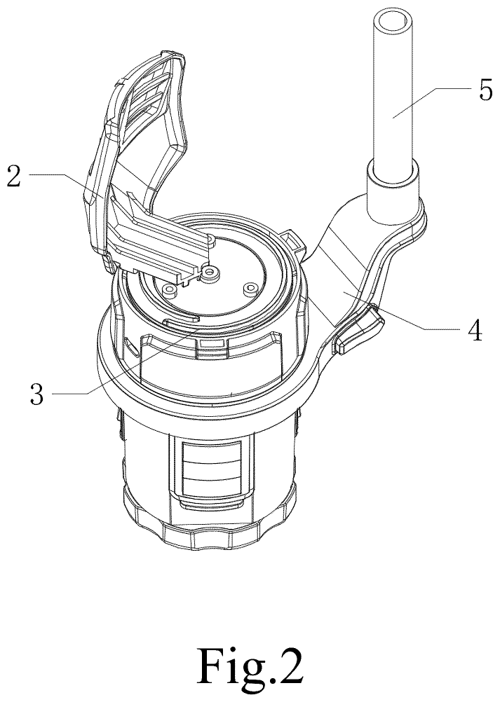

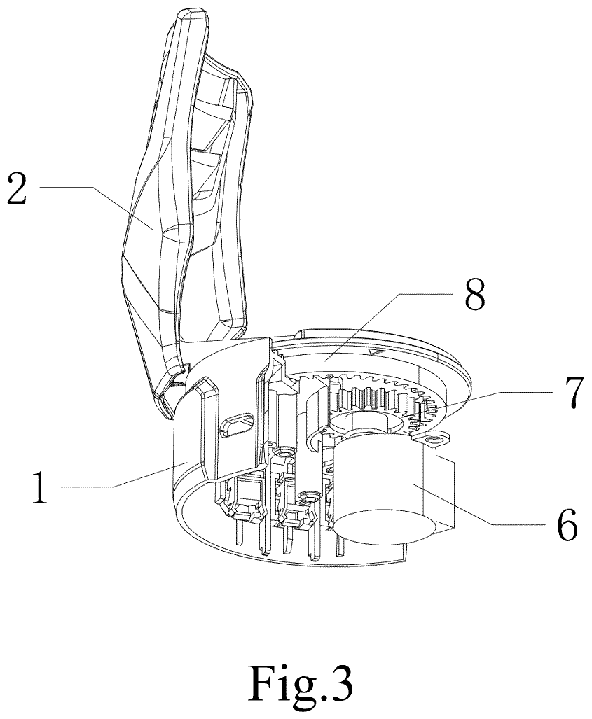

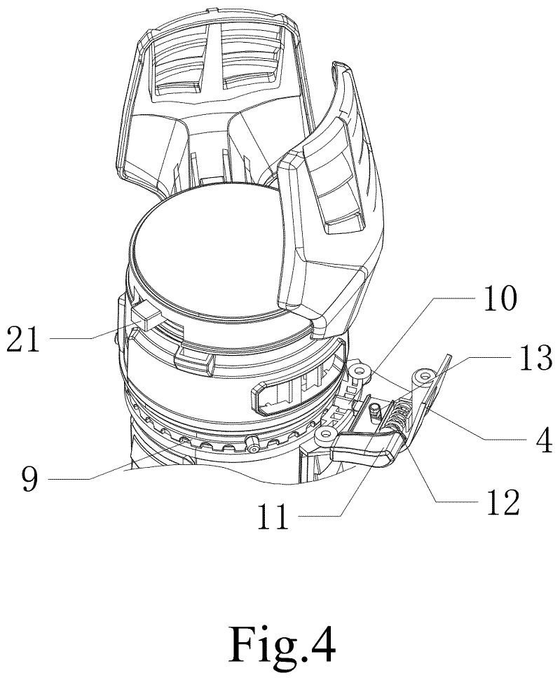

Referring to FIG. 1 to FIG. 7, a vehicle-mounted cup holder includes: a housing 1 and a telescopic base 16, where the housing 1 and the telescopic base 16 are configured to be retractable;
a driving assembly, disposed inside the housing 1; and
an adjusting assembly, located on a top of the housing 1 and cooperatively connected to the driving assembly, the adjusting assembly being configured to fix cups of different diameters, and the adjusting assembly opening during placement of the cup on the top of the housing 1, and clamping after completion of the placement.

Referring to FIG. 1 to FIG. 3, the driving assembly includes: a first gear motor 6,
the first gear motor 6 being located inside the housing 1;
a first gear 7, fixedly connected to an output end of the first gear motor 6 by way of a rotating shaft; and
a first annular gear 8, rotatably connected to the housing 1, the first gear 7 driving the first annular gear 8 to rotate.

Due to arrangement of the driving assembly, a plurality of moving blocks 2 can be driven to move horizontally according to the size of the cup. Specifically, when the moving blocks 2 need to be moved, the first gear motor 6 is started, the first gear motor 6 drives the first gear 7 to rotate, and the first gear 7 rotates to drive the first annular gear 8 to rotate, thereby driving a first threaded track 3 to rotate.

Referring to FIG. 1 to FIG. 3, the adjusting assembly includes a first threaded track 3, and the first threaded track 3 is fixedly connected to a top of the first annular gear 8; a plurality of bumps 21 are connected to the top end of the housing 1, and the plurality of bumps 21 are respectively located at inner sides of corresponding moving blocks 2; each of the moving blocks 2 is slidably connected to the first threaded track 3, a plurality of sliding grooves are provided inside the housing 1, the plurality of moving blocks 2 are slidably connected to the sliding grooves, and the plurality of moving blocks 2 are driven to move horizontally by rotation of the first threaded track 3; and a telescopic assembly is disposed below the adjusting assembly.

Due to arrangement of the adjusting assembly, cups with different diameters can be fixed. Specifically, in the case where the first gear motor 6 drives the first threaded track 3 to rotate, the plurality of moving blocks 2 can be driven to slide horizontally inside the sliding grooves of the housing 1, and thus the cup is clamped and fixed, which improves the convenience of taking.

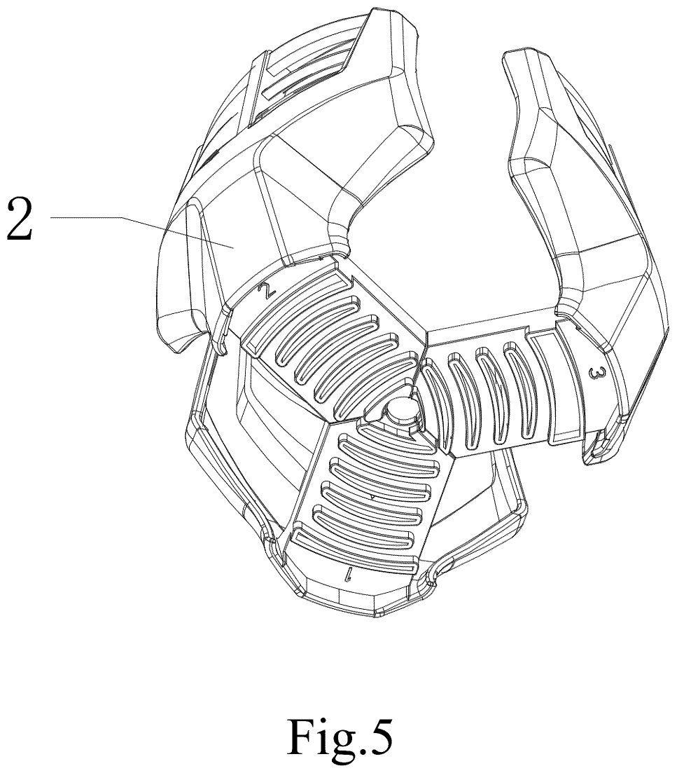

A bottom of each of the moving blocks 2 is marked with a number (referring to FIG. 5) for facilitating later assembly.

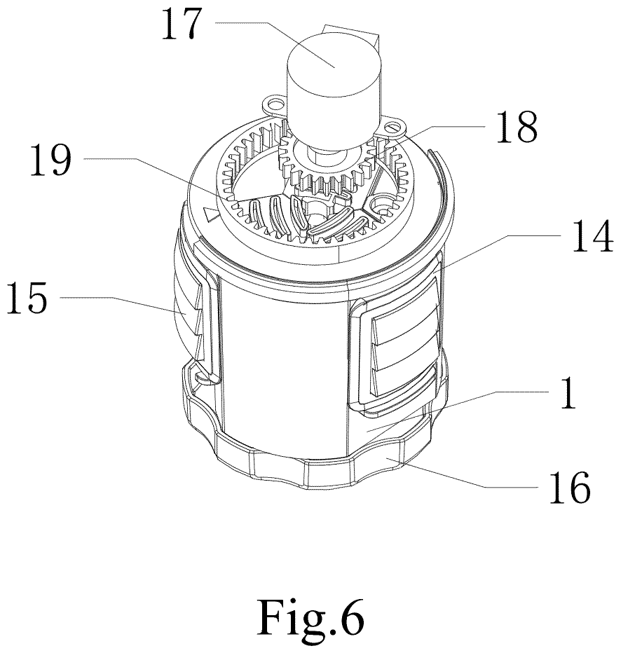

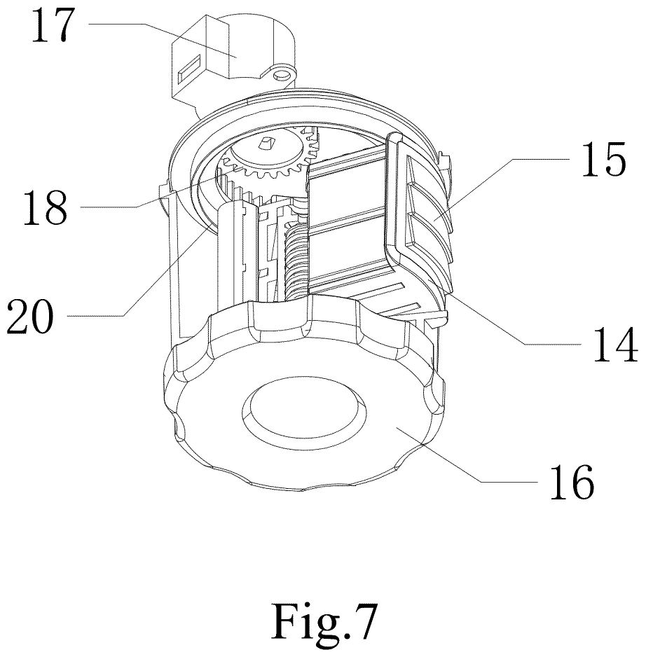

Referring to FIG. 6 to FIG. 7, the telescopic assembly includes a second gear motor 17, and an output end of the second gear motor 17 is connected to a second gear 18 by way of a rotating shaft; a second annular gear 19 is rotatably connected inside the housing 1, and a bottom of the second annular gear 19 is fixedly connected to a second threaded track 20; one end of the second threaded track 20 is slidably connected with a plurality of moving plates 14, the plurality of sliding grooves are provided at one end of the housing 1, and the plurality of sliding grooves are slidably connected to the corresponding moving plates 14, respectively; and the plurality of moving plates 14 are horizontally retractable and can be more tightly connected to an inner wall of an original cup holder. Each of the plurality of moving plates 14 is internally provided a soft rubber insert 15, and a plurality of soft rubber inserts 15 can avoid the inner wall of the original cup holder being scratched when in contact with same.

The telescopic assembly is configured to enable the moving plates 14 to be abutted against the inner wall of the original cup holder, providing better support and fixation. Specifically, the vehicle-mounted cup holder is placed inside the original cup holder first, and the second gear motor 17 is started; the second gear motor 17 drives the second gear 18 to rotate, the second annular gear 19 is driven to rotate by rotation of the second gear 18, the second threaded track 20 is driven to rotate by rotation of the second annular gear 19, and the second threaded track 20 drives the plurality of moving plates 14 to slide horizontally in the sliding grooves; the soft rubber inserts 15 are enabled to contact with the inner wall of the original cup holder, which can avoid the original cup holder being scratched; moreover, the soft rubber inserts 15 will cause slight deformation with the original cup holder, thus increasing the contact area and friction force; and such friction force helps to maintain the stability of the moving plates 14 in the original cup holder and prevents the moving plates from sliding while ensuring a tight fit between the moving plates 14 and the inner wall of the original cup holder.

Referring to FIG. 1 to FIG. 4, an expandable base 4 is disposed at one end of the housing 1, a connecting ring 9 is fixedly connected inside the expandable base 4, and the connecting ring 9 is rotatably connected to the housing 1; the connecting ring 9 is internally provided with a plurality of through holes; one end of the expandable base 4 is slidably connected to a press block 11, one end of the press block 11 is fixedly connected to a spring 12, and one end of the spring 12 far away from the press block 11 is fixedly connected to the expandable base 4; one end of the press block 11 is fixedly connected to a connecting plate 13, and the connecting plate 13 is internally provided with a chute; a clamping rod 10 is slidably connected inside the expandable base 4, one end of the clamping rod 10 is slidably connected to the chute formed in the connecting plate 13, and the other end of the clamping rod 10 is matched with the through hole; one end of the expandable base 4 is in a threaded connection with a function extension lever 5; and the clamping rod 10 is configured to rotate and lock the expandable base 4.

Due to arrangement of the expandable base 4, some other storage spaces can be expanded. When the angle of the expandable base 4 needs to be adjusted, the press block 11 is pressed to drive the spring 12 to compress, so that the press block 11 is enabled to move forward. When the press block 11 moves forward, one end of the connecting plate 13 is driven to slide inside the chute, causing the clamping rod 10 to detach from the interior of the through hole; and at this point, the expandable base 4 can be rotated. When the expandable base is rotated to a desired angle, the press block 11 is released, and then the clamping rod 10 is clamped into the through hole, so that the expandable base 4 is locked.

In addition, the expandable base 4 can be expanded to form some other storage spaces when necessary, such as providing a storage tray, a holder for storing french fries, a mobile phone holder, and other functions, which improves the functionality and practicability of the cup holder.

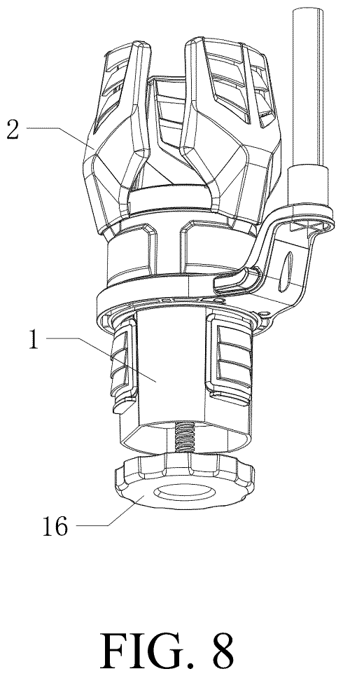

Referring to FIG. 6 to FIG. 8, the top of the housing 1 is fixedly connected with a cushion, the housing 1 is in a threaded connection with the telescopic base 16, and the telescopic base 16 can adjust the overall length of the housing 1 so as to adapt to a deeper original cup holder.

The overall length of the housing I can be adjusted by way of the telescopic base 16. The original cup holder depths of various vehicles differ from one another. When the original cup holder is deeper, the telescopic base 16 can be manually rotated to adjust the overall length of the housing 1. By lengthening the telescopic base 16, the bottom suspension of a groove between the original cup holder and the vehicle-mounted cup holder can be avoided; and in this way, the purpose of matching cup holders with different types of depths can be achieved.

Working principle: When in use, the telescopic base 16 is first rotated according to the depth of the original cup holder, the housing 1 is lengthened by adjustment, and then the vehicle-mounted cup holder is placed into the original cup holder; the second gear motor 17 is started, the second gear motor 17 drives the second gear 18 to rotate, the second annular gear 19 is driven to rotate by rotation of the second gear 18, the second threaded track 20 is driven to rotate by rotation of the second annular gear 19, and the second threaded track 20 drives the plurality of moving plates 14 to slide horizontally in the sliding grooves; the soft rubber inserts 15 are enabled to be abutted against the inner wall of the original cup holder, and then a cup is placed above the cushion of the housing 1; the first gear motor 6 drives the first gear 7 to rotate, and the first annular gear 8 is driven to rotate by rotation of the first gear 7, thereby driving the first threaded track 3 to rotate; and the plurality of moving blocks 2 are configured to clamp and limit an outer wall of the cup, which limits the movement of the cup, thus reducing the possibility of accidental falling.

The foregoing descriptions are exemplary embodiments of the present application, and are not intended to limit the scope of protection of the present application. Therefore, any equivalent changes made in accordance with the structure, shape and principle of the present application shall be covered by the scope of protection of the present application.

What is claimed is:

1. A vehicle-mounted cup holder, comprising:
a housing (1) and a telescopic base (16), wherein the housing (1) and the telescopic base (16) are configured to be retractable;
a driving assembly, disposed inside the housing (1); and
an adjusting assembly, located on a top of the housing (1) and cooperatively connected to the driving assembly, the adjusting assembly being configured to fix cups of different diameters, and the adjusting assembly opening during placement of the cup on the top of the housing (1), and clamping after completion of the placement.

2. The vehicle-mounted cup holder according to claim 1, wherein the driving assembly comprises:
a first gear motor (6), located inside the housing (1);
a first gear (7), fixedly connected to an output end of the first gear motor (6) by way of a rotating shaft; and
a first annular gear (8), rotatably connected to the housing (1), the first gear (7) driving the first annular gear (8) to rotate.

3. The vehicle-mounted cup holder according to claim 1, wherein the adjusting assembly comprises a first threaded track (3), and the first threaded track (3) is fixedly connected to a top of a first annular gear (8); a plurality of bumps (21) are connected to the top end of the housing (1), and the plurality of bumps (21) are respectively located at inner sides of corresponding moving blocks (2); each of the moving blocks (2) is slidably connected to the first threaded track (3), a plurality of sliding grooves are provided inside the housing (1), the plurality of moving blocks (2) are slidably connected to the sliding grooves, and the plurality of moving blocks (2) are driven to move horizontally by rotation of the first threaded track (3); and a telescopic assembly is disposed below the adjusting assembly.

4. The vehicle-mounted cup holder according to claim 3, wherein the telescopic assembly comprises a second gear motor (17), and an output end of the second gear motor (17) is connected to a second gear (18) by way of a rotating shaft; a second annular gear (19) is rotatably connected inside the housing (1), and a bottom of the second annular gear (19) is fixedly connected to a second threaded track (20); one end of the second threaded track (20) is slidably connected with a plurality of moving plates (14), the plurality of sliding grooves are provided at one end of the housing (1), and the plurality of sliding grooves are slidably connected to the corresponding moving plates (14), respectively; and the plurality of moving plates (14) are horizontally retractable and can be more tightly connected to an inner wall of an original cup holder.

5. The vehicle-mounted cup holder according to claim 4, wherein each of the plurality of moving plates (14) is internally provided a soft rubber insert (15), and a plurality of soft rubber inserts (15) can avoid the inner wall of the original cup holder being scratched when in contact with same.

6. The vehicle-mounted cup holder according to claim 1, wherein an expandable base (4) is disposed at one end of the housing (1), a connecting ring (9) is fixedly connected inside the expandable base (4), and the connecting ring (9) is rotatably connected to the housing (1).

7. The vehicle-mounted cup holder according to claim 6, wherein the connecting ring (9) is internally provided with a plurality of through holes; one end of the expandable base (4) is slidably connected to a press block (11), one end of the press block (11) is fixedly connected to a spring (12), and one end of the spring (12) far away from the press block (11) is fixedly connected to the expandable base (4); one end of the press block (11) is fixedly connected to a connecting plate (13), and the connecting plate (13) is internally provided with a chute; a clamping rod (10) is slidably connected inside the expandable base (4), one end of the clamping rod (10) is slidably connected to the chute formed in the connecting plate (13), and an other end of the clamping rod (10) is matched with the through hole; one end of the expandable base (4) is in a threaded connection with a function extension lever (5); and the clamping rod (10) is configured to rotate and lock the expandable base (4).

8. The vehicle-mounted cup holder according to claim 1, wherein the top of the housing (1) is fixedly connected with a cushion, the housing (1) is in a threaded connection with the telescopic base (16), and the telescopic base (16) can adjust an overall length of the housing (1) so as to adapt to a deeper original cup holder.
